(19) United States
(12) Patent Application Publication
(10) Pub. No.: US 2006/0053420 A1
(43) Pub. Date: Mar. 9, 2006

(54) Program downloading apparatus and method camera system

(76) Inventor: Takumi Soga, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/220,351

(22) Filed: Sep. 6, 2005

(30) Foreign Application Priority Data
Sep. 8, 2004 (JP) 2004-261225

(51) Int. Cl. G06F 9/445

(52) U.S. Cl. 717/174

(57) ABSTRACT

In a program downloading apparatus, a suspension signal is applied from the external device to the CPU thereby to suspend the operation of the CPU. While the operation of the CPU is suspended, a predetermined program is transmitted from the external device to and stored in the built-in memory. Upon completion of the transmission of the program, the suspension of operation of the CPU is canceled. Then, upon receipt of the switching signal from the external device, the CPU switches from the external memory to the built-in memory as a memory to access the address at the time of reset cancellation. Further, the CPU, upon receipt of the RESET signal from the external device and reset cancellation, executes the predetermined program stored in the built-in memory.

### CROSS-REFERENCE TO RELATED APPLICATIONS

This application is based upon and claims the benefit of priority from prior Japanese Patent Application No. 2004-261225, filed Sep. 8, 2004, the entire contents of which are incorporated herein by reference.

### BACKGROUND OF THE INVENTION

1. Field of the Invention

This invention relates to a program downloading apparatus and method and a camera system.

2. Description of the Related Art

A nonvolatile external memory such as a flash memory has built therein a main program such as a sequence control program and an image processing program. In this case, a CPU, if reset by an external device (or a master device), reads the main program from the external memory and executes the main program.

Jpn. Pat. No. 2556268, for example, discloses a system including a plurality of processors having a master processor and a slave processor connected to the master processor through a system bus, wherein the slave processor is reset into off state so that the program can be rapidly downloaded from the master processor to a volatile local memory of the slave processor through a system bus.

### BRIEF SUMMARY OF THE INVENTION

In order to achieve the above object, according to a first aspect of the present invention, there is provided a program downloading apparatus for a system comprising a first device having a flash memory for storing an operating program and a second device using a predetermined program corresponding to a part or the whole of the operating program downloaded from the first device, wherein the second device comprises a CPU, a volatile built-in memory, a nonvolatile external memory for storing a control program of the CPU, and a first switching unit which switches a memory with an address accessed by the CPU at the time of canceling the reset state, between the nonvolatile external memory and the volatile built-in memory in response to a switching signal from the first device, wherein the first device comprises a suspension instruction unit which transmits a suspension signal and suspends the operation of the CPU, a transfer storage unit which transmits the predetermined program to and stores the predetermined program in the volatile built-in memory during the suspension of operation of the CPU, a suspension cancellation unit which transmits a suspension cancel signal and cancels the suspension of operation of the CPU upon completion of the transmission of the program, a switch instruction unit which transmits the switching signal giving an instruction to switch a memory with an address accessed by the CPU from the nonvolatile external memory to the volatile built-in memory at the time of canceling the reset state, and an execution instruction unit which transmits the CPU reset cancel signal and executes the predetermined program stored in the volatile built-in memory.

According to a second aspect of the present invention, there is provided a program downloading apparatus for a camera system comprising a first device having at least a CPU, a flash memory for storing an operating program of the CPU and a serial I/F, and a second device using a predetermined program corresponding to a part or the whole of the operating program downloaded from the first device through the serial I/F, wherein the second device comprises a CPU, a volatile built-in memory, a nonvolatile external memory for storing the operating program of the CPU, and a first switching unit which switches a memory with an address accessed by the CPU at the time of canceling the reset state, between the nonvolatile external memory and the volatile built-in memory in response to a switching signal from the first device, wherein the first device comprises a suspension instruction unit which transmits a suspension signal and suspends the operation of the CPU, a transfer storage unit which transmits the predetermined program to the volatile built-in memory and stores the predetermined program in the volatile built-in memory during the suspension of operation of the CPU, a suspension cancellation unit which transmits a suspension cancel signal and cancels the suspension of operation of the CPU upon completion of the transmission of the program, a switch instruction unit which transmits the switching signal giving an instruction to switch a memory with an address accessed by the CPU at the time of canceling the reset state, from the nonvolatile external memory to the volatile built-in memory, and an execution instruction unit which transmits the CPU reset cancel signal and executing the predetermined program stored in the volatile built-in memory.

According to a third aspect of the present invention, there is provided a program downloading method for a system comprising a first device having a flash memory for storing an operating program, and a second device including a CPU, a volatile built-in memory, a nonvolatile external memory for storing a control program of the CPU, and a first switching unit which switches a memory with an address accessed at the time of canceling the reset state, between the nonvolatile external memory and the volatile built-in memory by a switching signal from the first device, wherein the second device uses a predetermined program corresponding to a part or the whole of the operating program downloaded from the first device, the method comprising the steps of: suspending the operation of the CPU by a suspension signal from the first device; transmitting a predetermined program to the volatile built-in memory from the first device and storing the predetermined program in the volatile built-in memory while the operation of the CPU is suspended; canceling the suspension of operation of the CPU by transmitting a suspension cancel signal upon completion of the transmission of the program; switching a memory with an address accessed by the CPU in response to a switching signal from the first device, from the nonvolatile external memory to the volatile built-in memory; and executing the predetermined program stored in the volatile built-in memory by a reset signal from the first device.

According to a fourth aspect of the present invention, there is provided a program downloading method for a camera system comprising a first device including at least a CPU, a flash memory for storing an operating program of the CPU and a serial I/F, and a second device including a CPU, a volatile built-in memory, a nonvolatile external memory for storing the operation program of the CPU and a first switching unit which switches a memory with an address accessed at the time of canceling the reset state, between the nonvolatile external memory and the volatile built-in memory by a switching signal from the first device, the second device using a predetermined program corresponding to a part or the whole of the operating program downloaded from the first device through the serial I/F, the method comprising the steps of: suspending the operation of the CPU by a suspension signal from the first device; transmitting a predetermined program to the volatile built-in memory from the first device and storing the predetermined program in the volatile built-in memory while the operation of the CPU is suspended; canceling the suspension of operation of the CPU by transmitting a suspension cancel signal upon completion of the transmission of the program: switching a memory with an address accessed by the CPU, from the nonvolatile external memory to the volatile built-in memory in response to a switching signal; and executing the predetermined program stored in the volatile built-in memory by a reset cancel signal from the first device.

According to a fifth aspect of the present invention, there is provided a camera system comprising a first device having a flash memory for storing an operating program and a second device using a predetermined program corresponding to a part or the whole of the operating program downloaded from the first device, wherein the second device comprises a CPU, a volatile built-in memory, a nonvolatile external memory for storing a control program of the CPU, and a first switching unit which switches a memory with an address accessed by the CPU at the time of canceling the reset state, between the nonvolatile external memory and the volatile built-in memory by a switching signal from the first device; wherein the first device comprises a suspension instruction unit which transmits a suspension signal and suspends the operation of the CPU, a transfer storage unit which transmits the predetermined program to the volatile built-in memory and stores the predetermined program in the voltage built-in memory during the suspension of operation of the CPU, a suspension cancel unit which transmits a suspension cancel signal and cancels the suspension of operation of the CPU upon completion of the transmission of the program, a switching instruction unit which transmits the switching signal to switch a memory with an address accessed by the CPU at the time of cancellation of the reset state, from the nonvolatile external memory to the volatile built-in memory, and an execution instruction unit which transmits a CPU reset state cancel signal and executes the predetermined program stored in the volatile built-in memory.

According to a sixth aspect of the present invention, there is provided a camera system comprising a first device having at least a CPU, a flash memory for storing an operating program of the CPU and a serial IF, and a second device using a predetermined program corresponding to a part or the whole of the operating program downloaded from the first device through the serial I/F, wherein the second device comprises a CPU, a volatile built-in memory, a nonvolatile external memory for storing the operating program of the CPU, and a first switching unit which switches a memory with an address accessed by the CPU at the time of canceling the reset state, between the nonvolatile external memory and the volatile built-in memory by a switching signal from the first device; wherein the first device comprises a suspension instruction unit which transmits a suspension signal and suspends the operation of the CPU, a transfer storage unit which transmits the predetermined program to the volatile built-in memory and stores the predetermined program in the voltage built-in memory while the CPU operation is suspended, a suspension cancel unit which transmits a suspension cancel signal and cancels the suspension of operation of the CPU upon completion of the transmission of the program, a switch instruction unit which transmits the switching signal giving an instruction to switch a memory with an address accessed by the CPU at the time of cancellation of the reset state, from the nonvolatile external memory to the volatile built-in memory, and an execution instruction unit which transmits a CPU reset state cancellation signal and executes the predetermined program stored in the volatile built-in memory.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a general configuration of a system to which a program downloading method according to a first embodiment of the invention is applicable;

FIG. 2 is a diagram showing the manner in which a control program is read from an external memory 27 of a camera system 21 into a CPU 21;

FIG. 3 is a timing chart corresponding to the process shown in FIG. 2;

FIG. 4 is a diagram showing the manner of reading an operating program from a flash memory 11 in an external device 10 into a built-in memory 25 through a first serial I/F 24;

FIG. 5 is a timing chart corresponding to FIG. 4;

FIG. 6 is a diagram showing the manner in which upon completion of the maintenance, a maintenance end notice and a maintenance OK/NG signal are transmitted to the external device 10 through a second serial I/F 23;

FIG. 7 is a flowchart for explaining the steps of starting the operating program from the built-in memory in accordance with the signal exchange between the external device 10 and the camera system 20;

FIG. 8 is a diagram showing the manner in which an external memory 27 or a built-in memory 25 is selected in accordance with the SEL signal level;

FIG. 9 is a diagram showing a general configuration of a camera system to which the program downloading method according to a second embodiment of the invention is applicable;

FIG. 10 is a diagram showing the manner in which the camera program is read from the external memory 127 of the camera system 200 into the CPU 121;

FIG. 11 is a timing chart corresponding to the process shown in FIG. 10;

FIG. 12 is a diagram showing the manner of reading the operating program from the flash memory 111 in the external device 10 into the built-in memory 125 through the first serial I/F 124;

FIG. 13 is a diagram showing the manner in which upon completion of the maintenance, a program execution end notice and an operation OK/NG signal are transmitted to the master device 110 through the second serial I/F 123; and

FIG. 14 is a flowchart for explaining the steps of starting the operating program from the built-in memory in accordance with the signal exchange between the master device 110 and the slave device 120.

### DETAILED DESCRIPTION OF THE INVENTION

Embodiments of the invention are explained in detail below with reference to the drawings.

### First Embodiment

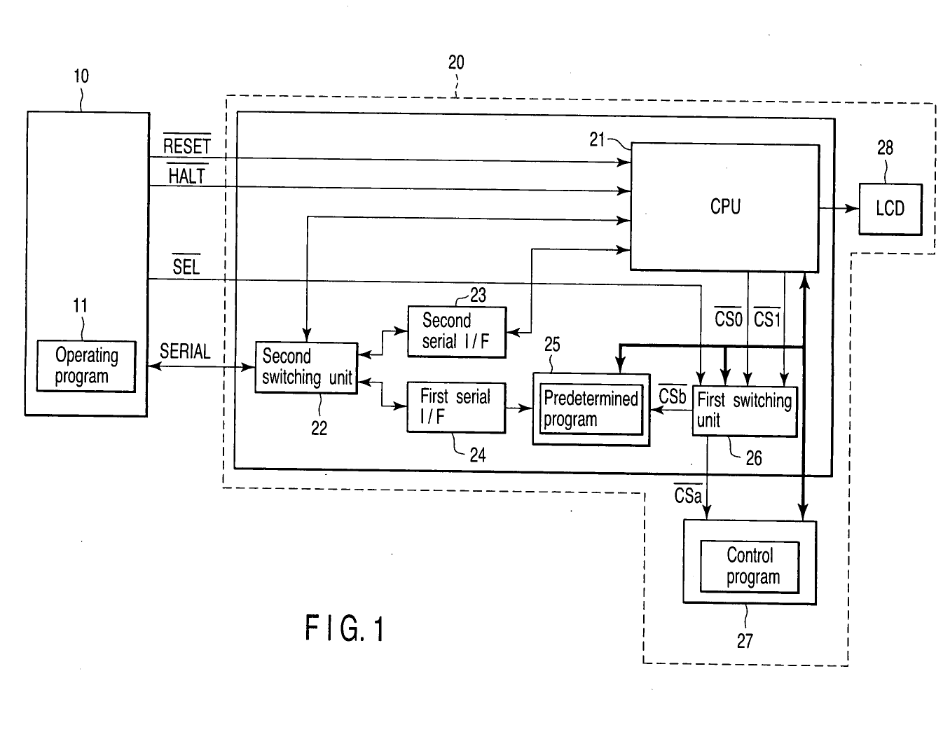

A general configuration of a system using the program downloading method according to a first embodiment of the invention is shown in FIG. 1. This system is configured of an external device 10 as a first device and a camera system 20 as a second device connected to the external device 10. The external device 10 includes a flash memory 11 for storing the operating program.

The camera system 20 is used by downloading a predetermined program having a part or the whole of the operating program from the external device 10, and as a first configuration, includes a CPU 21, a volatile built-in memory 25 for storing a predetermined program, a nonvolatile external memory 27 for storing the control program for the CPU 21, and a first switching unit 26 for switching the memory with the address accessed at the time of canceling the reset state between the external memory 27 and the built-in memory 25 by a switching signal (SEL signal) from the external memory 10. Further, a LDC 28 may be provided as a display unit. The built-in memory 25 described above is implemented by a built-in RAM, for example. Also, the external memory 27 is implemented by a flash memory, for example. Furthermore, as one aspect of the invention, the external device 10 is an entity independent of the camera system 20, and the operating program and the predetermined program described above make up a maintenance program for the camera system.

In the configuration described above, a suspension signal (a HALT signal) is applied from the external device 10 to the CPU 21 thereby to suspend the operation of the CPU 21. While the operation of the CPU 21 is suspended, a predetermined program is transmitted from the external device 10 to and stored in the built-in memory 25. Upon completion of the transmission of the program, the suspension of operation of the CPU 21 is canceled. Then, upon receipt of the switching signal (SEL) from the external device 10, the CPU 21 switches from the external memory 27 to the built-in memory 25 as a memory to access the address at the time of reset cancellation. Further, the CPU 21, upon receipt of the RESET signal from the external device 10 and reset cancellation, executes the predetermined program stored in the built-in memory 25.

As a second configuration, the camera system 20, in addition to the first configuration described above, further comprises a first serial I/F 24 for receiving the predetermined program from the external device 10 and transmitting it to the built-in memory 25.

Further, in addition to the first and second configurations described above, the camera system 20 has a third configuration comprising a second serial I/F 23 for communication with the CPU 21 and transmitting a predetermined program execution end signal and an operation OK/NG signal to the external device 10 and a second switching unit 22 to switch the second serial I/F 23 for serial communication with the external device 10 in response to a RESET signal input (inverted at L level) from the external device 10 while the operation of the CPU 21 is suspended. According to this embodiment, the CPU 21, the built-in memory 25, the first switching unit 26, the first serial I/F 24, the second serial I/F 23 and the second switching unit 22 are arranged on the same semiconductor substrate.

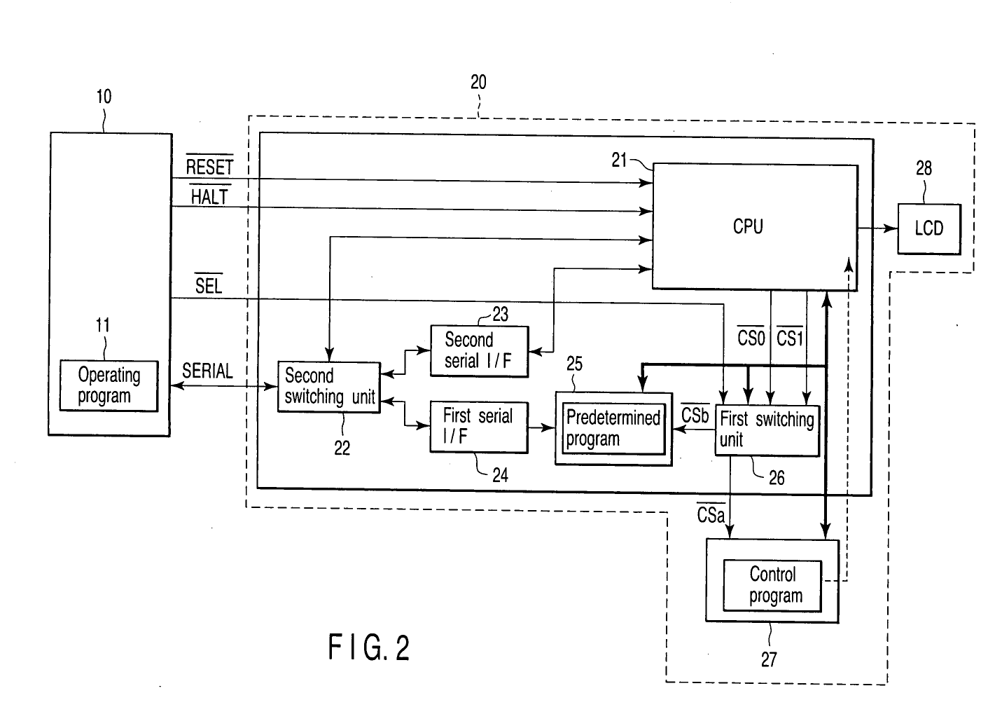

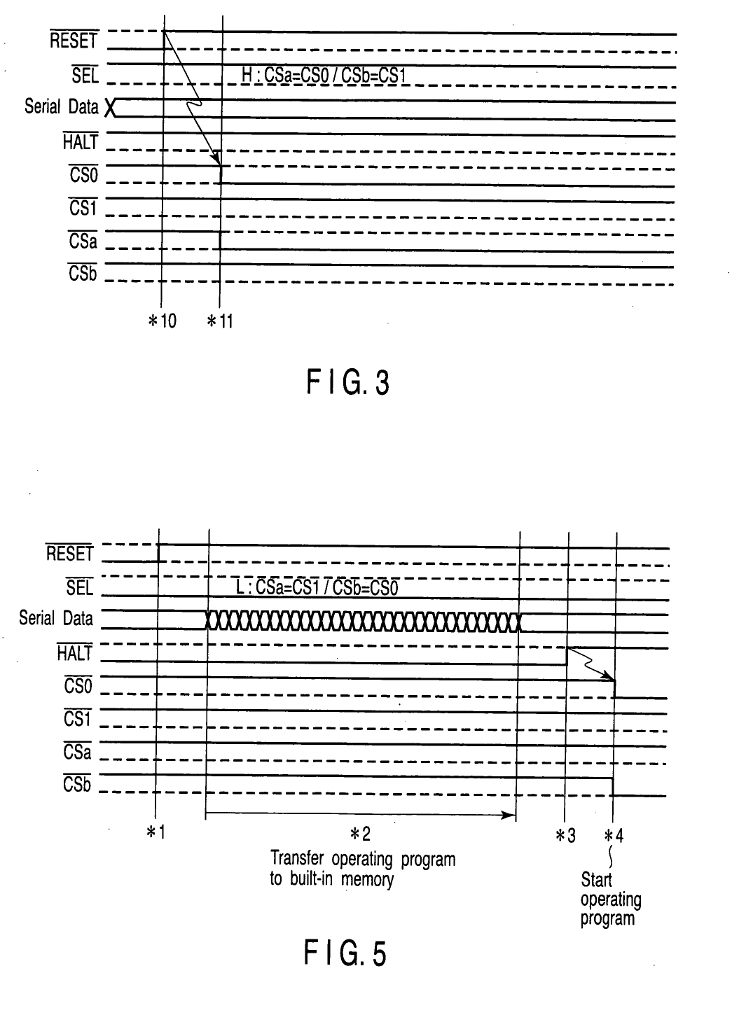

FIG. 2 shows the manner in which a control program is read from the external memory 27 of the camera system 20 into the CPU 21 (see dotted arrow 50), and FIG. 3 is a timing chart corresponding to the process shown in FIG. 2. With the external memory 27 selected (SEL signal inverted at H level), the reset state is canceled at timing *10, and then the CPU 21 reduces CS0 (inverted) and CSa (inverted) to L level at timing of *11 thereby to read the control program from the external memory 27.

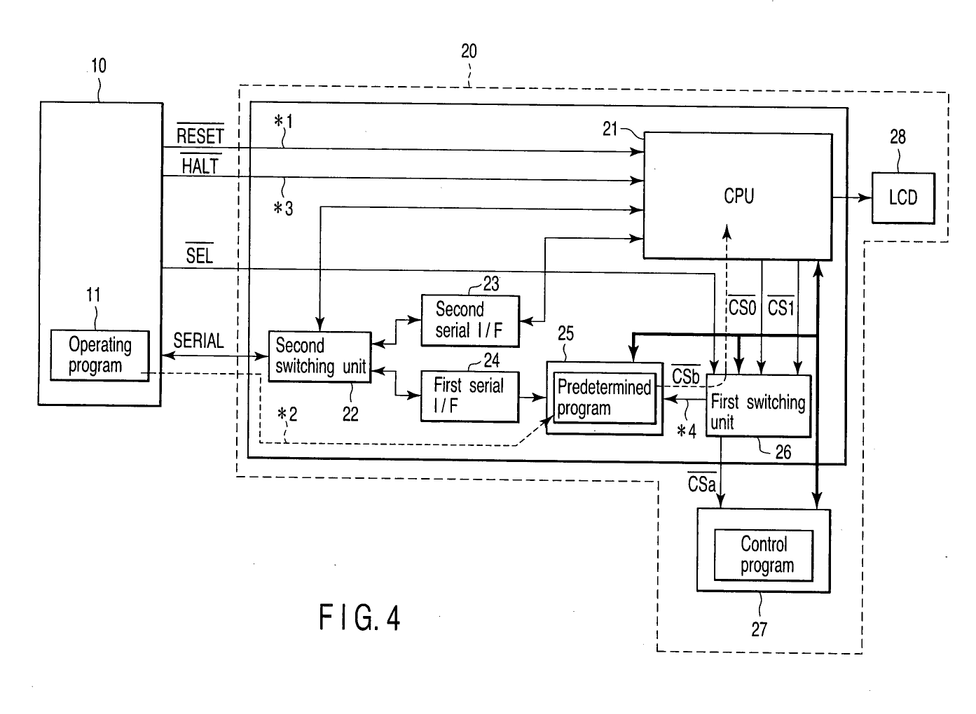

FIG. 4 shows the manner of the operation to read the operating program (the maintenance program in this case) into the built-in memory 25 from the flash memory 11 in the external device 10 through the first serial I/F 24. FIG. 5 is a timing chart corresponding to FIG. 4. In this case, a HALT signal (inverted at L level) is input to the CPU 21 of the camera system 20 from the external device 10 thereby to suspend the operation of the CPU 21, while at the same time selecting the built-in memory 25 (SEL signal inverted at L level). First, upon cancellation of the reset state at timing *1, the operating program is read from the flash memory 11 of the external device 10 and transferred to the built-in memory 25 through the first serial I/F 24 of the camera system 20 during the period indicated by *2. During this transfer period *2, the entire operating program is transferred, after which the HALT signal (inverted at H level) is input at timing *3 and canceled thereby to restart the operation of the CPU 21.

Next, at timing *4 when CSO (inverted) and CSb (inverted) are set to L level, the CPU 21 executes the maintenance by reading the operating program from the built-in memory 25.

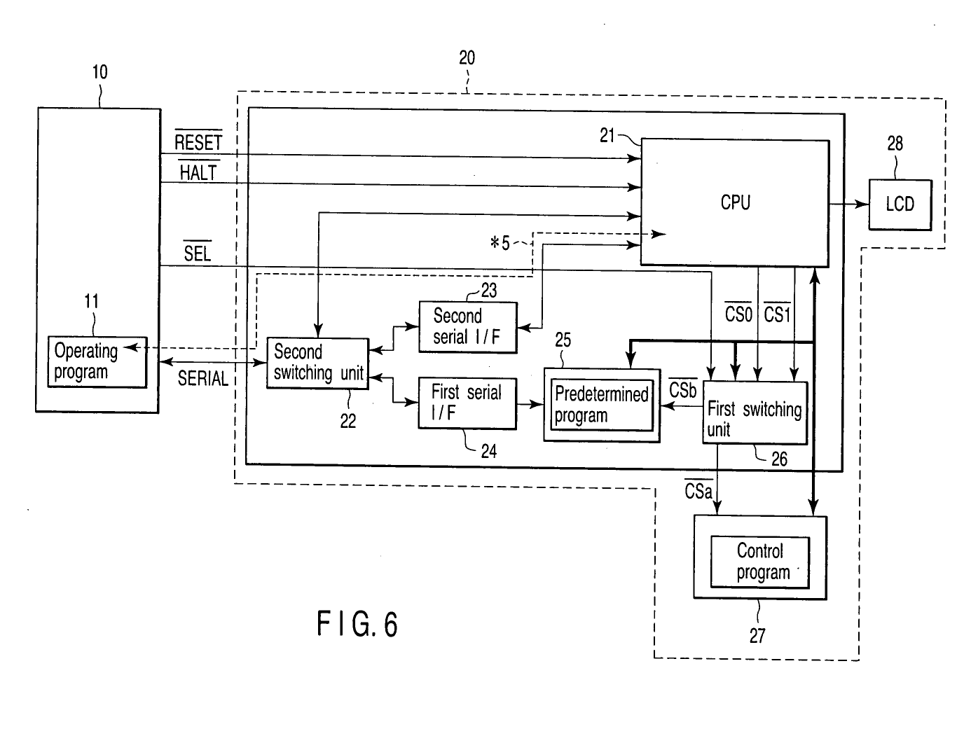

Upon completion of the maintenance, the CPU 21 of the camera system 20 transmits a maintenance end notice and a maintenance OK/NG signal to the external device 10 through the second serial I/F 23. The signal flow of this operation is shown by dotted line *5 in FIG. 6. In the external device 10, these information are displayed on a display unit (such as a LCD) not shown or aurally notified to the user. In similar fashion, the CPU 21 displays the information on the maintenance end and the maintenance OK/NG signal on the LCD 28, or announces them aurally to the user.

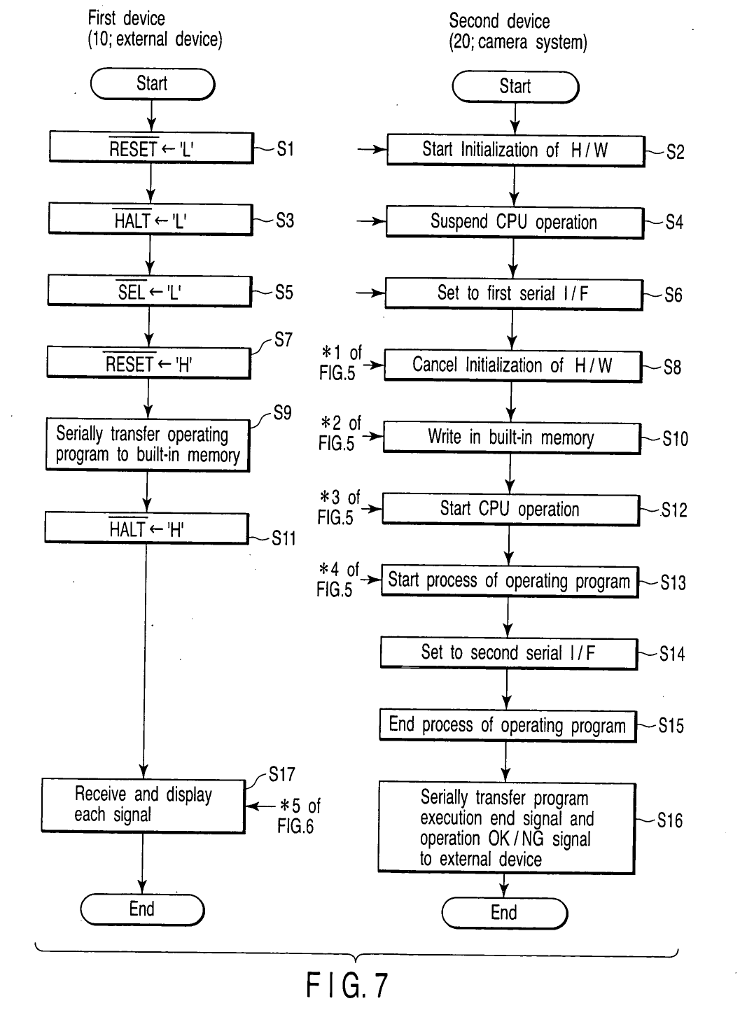

FIG. 7 is a flowchart for explaining the steps of starting the operating program from the built-in memory in accordance with the signal exchange between the external device 10 and the camera system 20. With the external device 10 and the camera system 20 connected to each other, the external device 10 sets the RESET signal (inverted) to L level (step S1). Then, the camera system 20 starts to initialize the hardware (step S2). Next, the external device 10 sets the HALT signal (inverted) at L level (step S3), so that the camera system 20 suspends the operation of the CPU 21 (step S4). The external device 10 sets the SEL signal (inverted) at L level (step S5), so that the camera system 20 is set to the first serial I/F 24 (step S6). Next, the external device 20 sets the RESET signal (inverted) at H level (step S7), and then the camera system 20 cancels the initialization of the hardware (step S8, *1 in FIG. 5).

Under this condition, the external device 10 serially transfers the operating program (maintenance program) to the built-in memory 25 (step S9), so that the camera system 20 writes the transferred operating program into the built-in memory 25 (step S10, *2 in FIG. 5). Next, the external device 10 sets the HALT signal (inverted) at H level (step S11), so that the HALT signal is canceled and the CPU 21 of the camera system 20 starts to operate (step S12, *3 in FIG. 5). As a result, the operating program of the built-in memory 25 is started and so is the maintenance process (step S13, *4 in FIG. 5).

Next, the CPU 21 controls and sets the second switching unit 22 to the second serial I/F 23 (step S14). Then, the CPU 21 finishes the maintenance process on the operating program (step S15). The CPU 21 transfers the program execution end signal and the operation OK/NG signal serially to the external device 10 (step S16) thereby to end the process. The external device 10 receives the program execution end signal and the operation OK/NG signal through the second serial I/F 23, and displays these information on a display unit (such as a LCD) not shown (step S17, *5 in FIG. 6). In similar fashion, the CPU 21 displays these information on the LCD 28 or aurally announces them to the user.

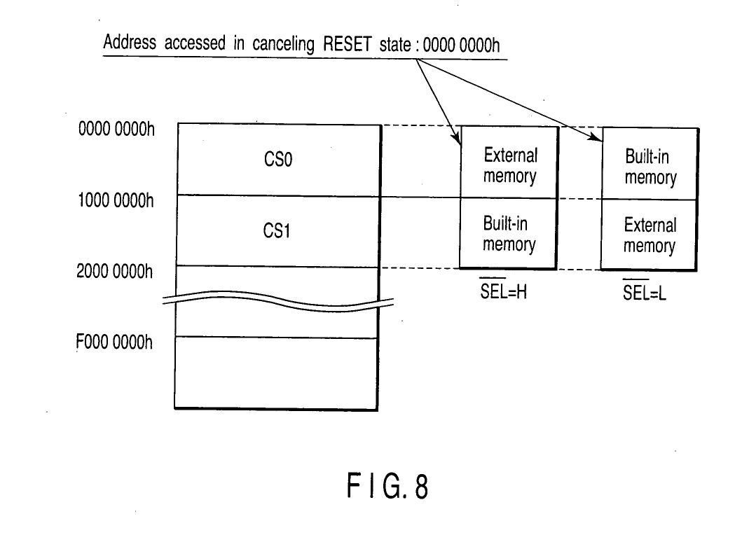

FIG. 8 shows the manner in which the external memory 27 or the built-in memory 25 is selected in accordance with the SEL signal level. Specifically, when starting the program from the external memory 27, the SEL signal (inverted) turns to H level and CS0 (inverted) and CSa to L level thereby to select the external memory 27. At the time of starting the program from the built-in memory 25, on the other hand, SEL signal (inverted), CSO (inverted) and CSb all turn to L level thereby to select the built-in memory 25.

According to the first embodiment described above, the maintenance process is executed by the program stored in the built-in memory 25, and therefore the nonvolatile external memory 27 is not required to be rewritten.

Also, in the case where the nonvolatile external memory 27 is rewritten, the data is normally required to be transmitted through an external bus of a multiplicity of wires. According to this embodiment, however, a fewer number of wires is required since the first serial I/F 24 is used.

### Second Embodiment

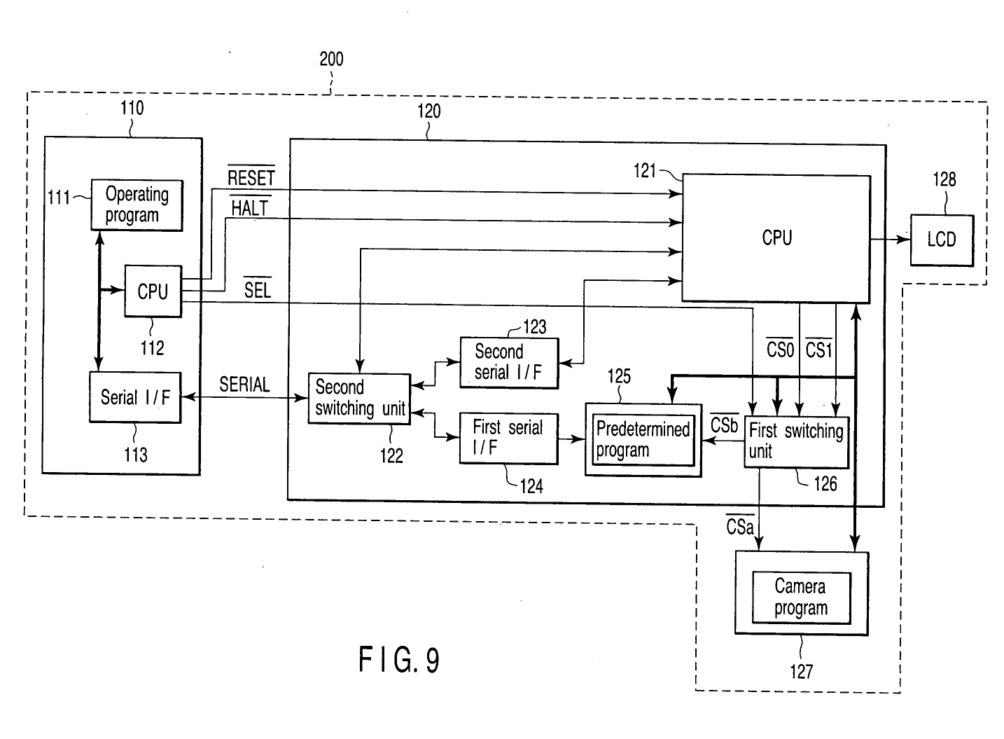

FIG. 9 is a diagram showing a general configuration of a camera system using the program downloading method according to a second embodiment of the invention. This camera system is configured of a master device 110 as a first device, and a slave device 120 as a second device connected to the master device 110. The master device 110 includes at least a CPU 112, a flash memory 111 for storing the operating program of the CPU 112 and a serial I/F 113.

The slave device 120 uses a predetermined program including a part or the whole of the operating program downloaded through the serial I/F 113 from the master device 110. The slave device 120 includes, as a first configuration, a CPU 121, a volatile built-in memory 125, a nonvolatile external memory 127 for storing the operating program of the CPU 121 and a first switching unit 126 for switching the memory with the address accessed at the time of canceling the reset state, between the external memory 127 and the built-in memory 125 by means of a switching signal (SEL signal) from the master device 110. Further, the slave device 120 may include a LCD 128 as a display unit. The built-in memory 125 can be implemented by, for example, a built-in RAM. Also, the external memory 127 can be implemented by a flash memory, for example. Also, as another aspect, the master device 110 is independent of the slave device 120, and the operating program is a main program including a control program and an image processing program of the camera system. The predetermined program is an image processing program of the camera system.

In the configuration described above, the HALT signal (inverted at L level) from the master device 110 suspends the operation of the CPU 121 of the slave device 120. During the suspension of operation of the CPU 121, a predetermined program is transmitted from the master device 110 to and stored in the built-in memory 125. Upon completion of the program transmission, the suspension of operation of the CPU 121 is also canceled, and the memory with the address accessed by the CPU 121 upon cancellation of the reset state is switched from the external memory 127 to the built-in memory 125. The CPU 121, upon receipt of the reset cancellation signal (RESET signal inverted at H level) from the master device 110, executes the predetermined program stored in the built-in memory 125.

Also, the slave device 120 further includes, as a second configuration in addition to the first configuration, a first serial I/F 124 for receiving a predetermined program from the master device 110 and transmitting it to the built-In memory 125.

Further, the slave device 120, as a third configuration in addition to the first and second configurations described above, further includes a second serial I/F 123 for conducting communication with the CPU 121 and transmitting the execution end signal for a predetermined program and the operation OK/NG signal to the master device 110, and a second switching unit 122 for switching the second serial I/F 123 in response to the RESET signal (inverted at L level) from the slave device 110 during the suspension of operation of the CPU 121 in such a manner that the serial communication with the master device 110 becomes possible. According to this embodiment, the CPU 121, the built-in memory 125, the first switching unit 126, the first serial I/F 124, the second serial I/F 123 and the second switching unit 122 are arranged on the same semiconductor substrate.

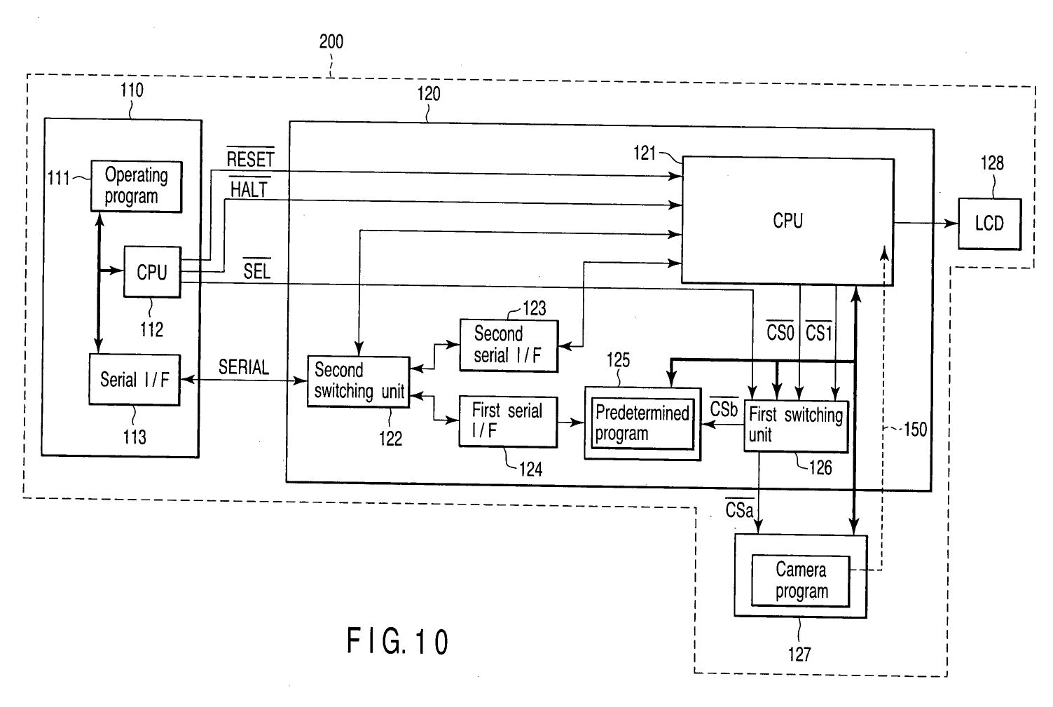

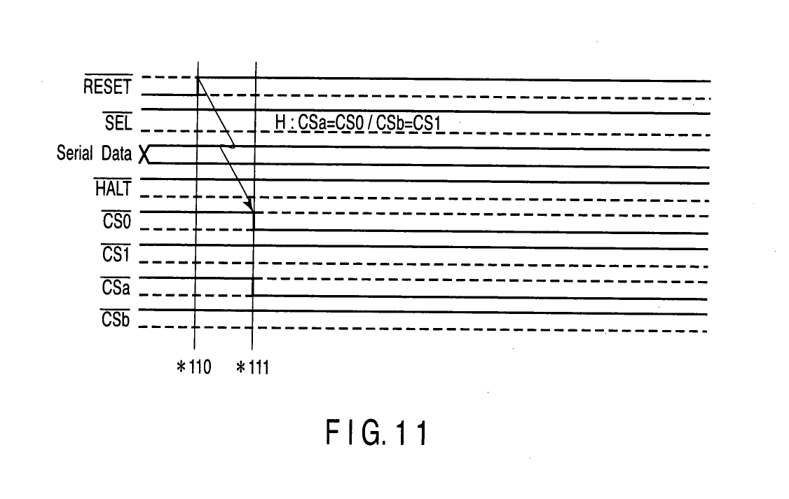

FIG. 10 shows the manner in which the control program is read from the external memory 127 of the slave device 120 into the CPU 121 (dotted arrow 150), and FIG. 11 a timing chart corresponding to the process shown in FIG. 10. In the case where the reset state is canceled at timing *11 with the external memory 127 selected (SEL signal inverted at H level), the CPU 121 turns CS0 (inverted) and CSa (inverted) to L level at timing of *111 thereby to read the control program from the external memory 27.

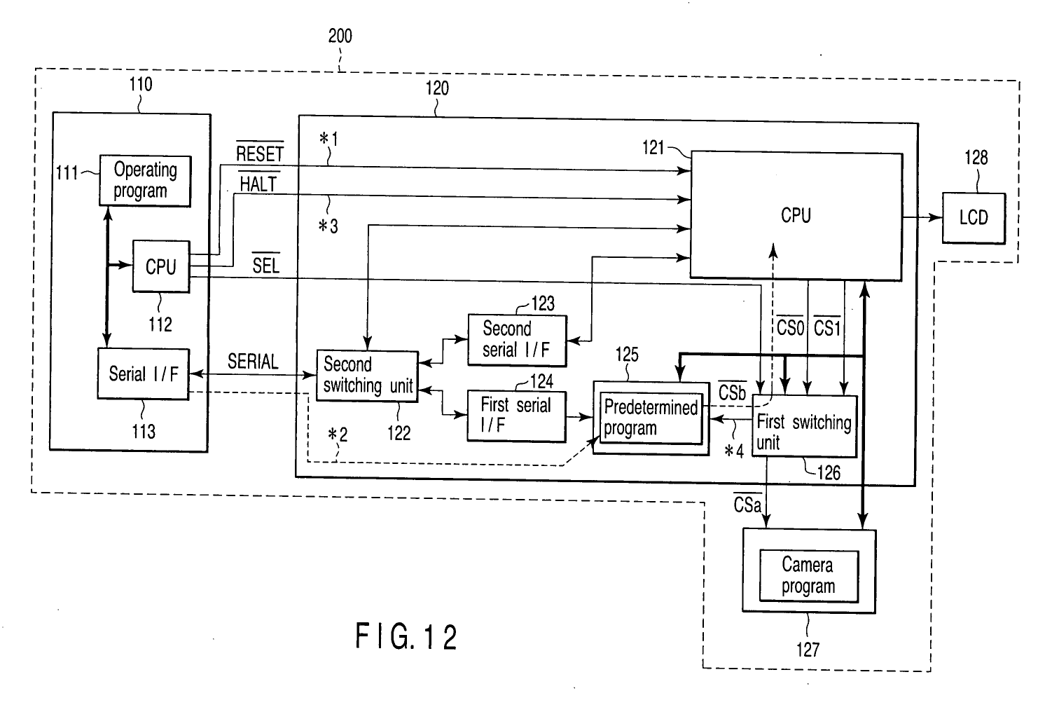

FIG. 12 shows the manner of reading the operating program (in this case, including the control program and the image processing program as a main program of the camera) into the built-in memory 125 through the serial I/F 113 and the first serial I/F 124 from the flash memory 111 in the master device 110. FIG. 5 can be used as a timing chart corresponding to FIG. 12. This timing chart, as described above, shows the state after the HALT signal (inverted at L level) is input from the master device 110 to the CPU 121 of the slave device 120 to suspend the operation of the CPU 121, while at the same time inputting the switching signal (SEL signal inverted at L level) from the master device 110 thereby to select the built-in memory 125.

First, once the reset state is canceled at timing *1 in FIG. 5, the operating program is read from the flash memory 111 of the master device 110, and transmitted to the slave device 120 through the serial I/F 113. In the slave device 120, the operating program is transferred to the built-in memory 125 through the first serial I/F 124 during the transfer period *2. After the entire operating program is transferred during this transfer period, the HALT signal is canceled at timing *3 thereby to restart the operation of the CPU 121.

Next, with the turning of CS0 (inverted) and CSb (inverted) to L level at timing *4, the CPU 121 reads the operating program from the built-in memory 125 and executes the image processing operation.

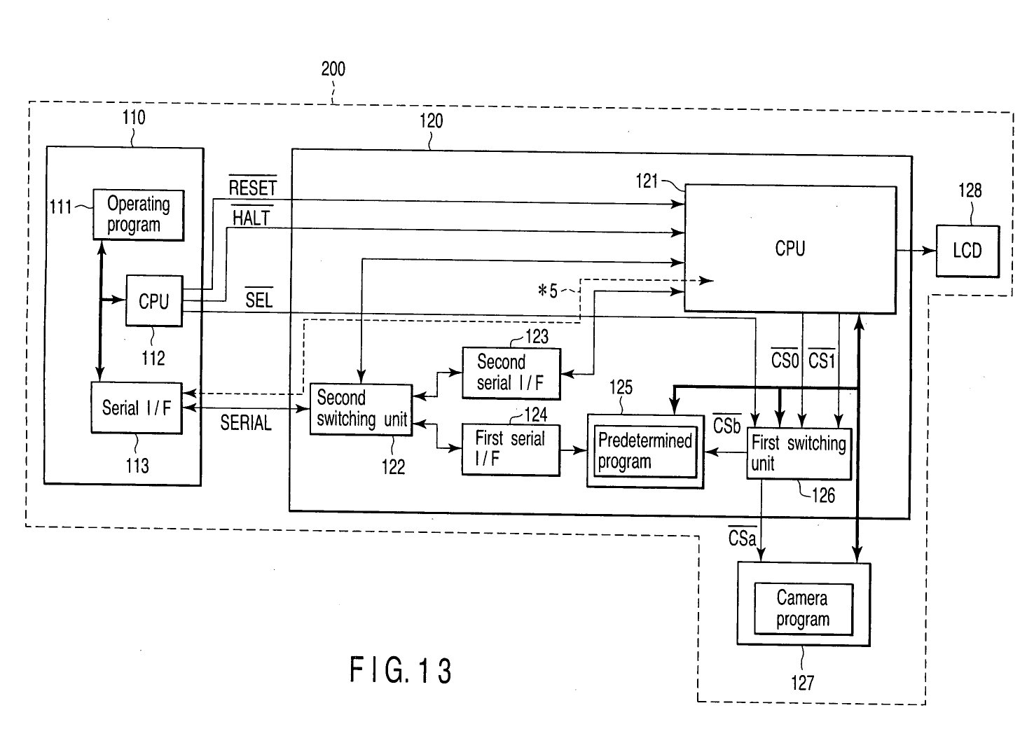

Upon completion of the image processing operation, the CPU 121 of the slave device 120 transmits the program execution end notice and the operation OK/NG signal to the master device 110 through the second serial I/F 123. The signal flow of this process is indicated by the dotted line *5 in FIG. 13. The second serial I/F 123 is also used to give an instruction from the master device 110 to the slave device 120 to execute a predetermined process. The master device 110 receives the program end signal and the operation OK/NG signal through the second serial I/F 123 and displays these information on a display unit (such as a LCD) not shown. The CPU 121 displays the information on the program execution end and the operation OK/NG signal on the LCD 128 or announces them aurally to the user.

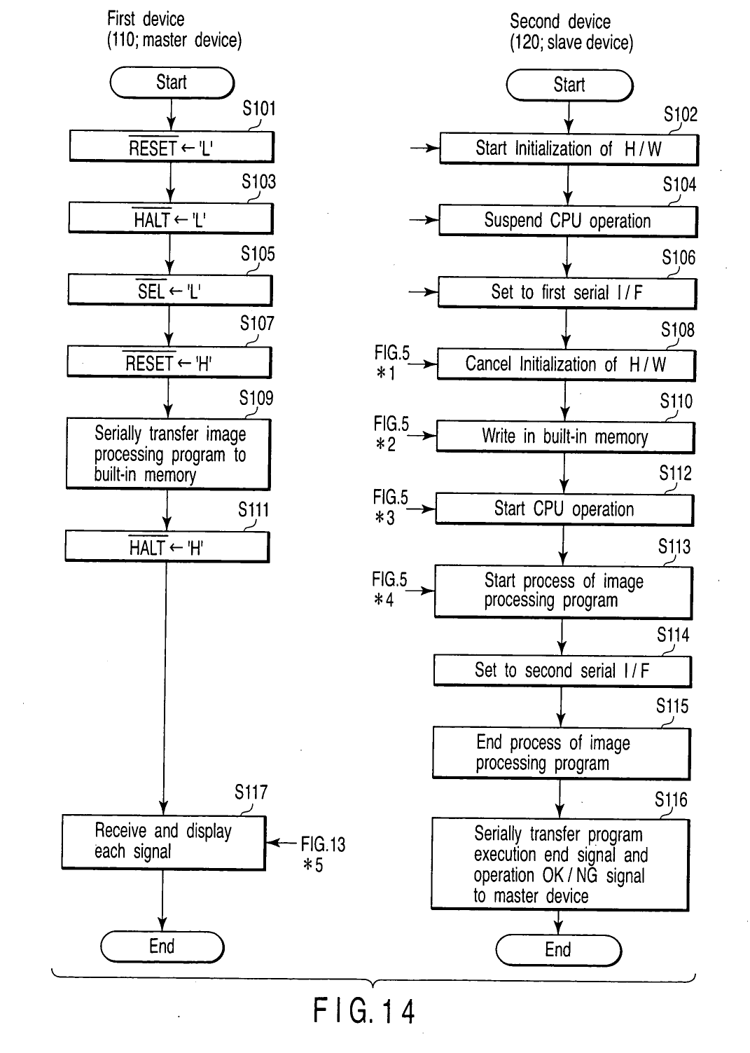

FIG. 14 is a flowchart for explaining the steps of starting the operating program from the built-in memory in accordance with the signal exchange between the master device 110 and the slave device 120. In the case where the RESET signal (inverted) is set to L level with the master device 110 and the slave device 120 connected with each other (step S101), the slave device 120 starts the hardware initialization (step S102). Next, the master device 110 sets the HALT signal (inverted) to L level (step S103). The slave device 120 suspends the operation of the CPU 121 (step S104). Next, the master device 110 sets the switching signal (SEL signal (inverted) to L level (step S105), and the slave device 120 is set to the first serial I/F 124 (step S106). Next, the slave device 120 sets the RESET signal (inverted) to H level (step S107). The slave device 120 cancels the hardware initialization (step S108, *1 in FIG. 5).

Under this condition, the master device 110 serially transfers the operating program (the main program for the camera including the control program and the image processing program) to the built-in memory (step S109). Then, the slave device 120 writes the transferred operating program into the built-in memory 125 (step S110, *2 in FIG. 5). Next, the master device 110 sets the HALT signal (inverted) to H level (step S111). The HALT signal is canceled, and the CPU 121 of the slave device 120 starts operating (step S112, *3 in FIG. 5). As a result, the operating program of the built-in memory 125 is started and the image processing operation is started (step S113).

The slave device 120 is set to the second serial I/F 123 (step S114). Next, the slave device 120 ends the image processing operation on the operating program (step S115). Then, the slave device 120 serially transfers the program execution end signal and the operation OK/NG signal to the master device 110 (step S116) thereby to end the process. The master device 110 receives and displays the program execution end signal and the operation OK/NG signal (step S117, *5 in FIG. 6). In similar fashion, the CPU 121 displays these information on the LCD 128 or announces aurally to the user.

According to the second embodiment described above, the image processing is carried out in accordance with the program stored in the built-in memory 125. Advantageously, therefore, the nonvolatile external memory is not required to be rewritten.

In the case where the nonvolatile external memory is rewritten, on the other hand, the data is required to be transmitted through an external bus having a multiplicity of wires. According to this embodiment, however, the number of wires is reduced by the use of the serial I/F.

What is claimed is:

1. A program downloading apparatus for a system comprising a first device having a flash memory for storing an operating program and a second device using a predetermined program corresponding to a part or the whole of the operating program downloaded from the first device,
wherein the second device comprises a CPU, a volatile built-in memory, a nonvolatile external memory for storing a control program of the CPU, and a first switching unit which switches a memory with an address accessed by the CPU at the time of canceling the reset state, between the nonvolatile external memory and the volatile built-in memory in response to a switching signal from the first device,
wherein the first device comprises a suspension instruction unit which transmits a suspension signal and suspends the operation of the CPU, a transfer storage unit which transmits the predetermined program to and stores the predetermined program in the volatile built-in memory during the suspension of operation of the CPU, a suspension cancellation unit which transmits a suspension cancel signal and cancels the suspension of operation of the CPU upon completion of the transmission of the program, a switch instruction unit which transmits the switching signal giving an instruction to switch a memory with an address accessed by the CPU from the nonvolatile external memory to the volatile built-in memory at the time of canceling the reset state, and an execution instruction unit which transmits the CPU reset cancel signal and executes the predetermined program stored in the volatile built-in memory.

2. A program downloading apparatus for a camera system comprising a first device having at least a CPU, a flash memory for storing an operating program of the CPU and a serial I/F, and a second device using a predetermined program corresponding to a part or the whole of the operating program downloaded from the first device through the serial I/F,
wherein the second device comprises a CPU, a volatile built-in memory, a nonvolatile external memory for storing the operating program of the CPU, and a first switching unit which switches a memory with an address accessed by the CPU at the time of canceling the reset state, between the nonvolatile external memory and the volatile built-in memory in response to a switching signal from the first device,
wherein the first device comprises a suspension instruction unit which transmits a suspension signal and suspends the operation of the CPU, a transfer storage unit which transmits the predetermined program to the volatile built-in memory and stores the predetermined program in the volatile built-in memory during the suspension of operation of the CPU, a suspension cancellation unit which transmits a suspension cancel signal and cancels the suspension of operation of the CPU upon completion of the transmission of the program, a switch instruction unit which transmits the switching signal giving an instruction to switch a memory with an address accessed by the CPU at the time of canceling the reset state, from the nonvolatile external memory to the volatile built-in memory, and an execution instruction unit which transmits the CPU reset cancel signal and executing the predetermined program stored in the volatile built-in memory.

3. The program downloading apparatus according to claim 1,
wherein the volatile built-in memory is a built-in RAM and the nonvolatile external memory is a flash memory.

4. The program downloading apparatus according to claim 2,
wherein the volatile built-in memory is a built-in RAM and the nonvolatile external memory is a flash memory.

5. The program downloading apparatus according to claim 1,
wherein the second device further has a first serial I/F which receives a predetermined program from the first device and transmits the received predetermined program to the volatile built-in memory.

6. The program downloading apparatus according to claim 2,
wherein the second device further has a first serial I/F which receives a predetermined program from the first device and transmits the received predetermined program to the volatile built-in memory.

7. The program downloading apparatus according to claim 5,
wherein the second device further has a second serial I/F which communicates with the CPU and transmits a signal indicating the end of execution of a predetermined program and an operation OK/NG signal to the first device, and a second switching unit which switches the second serial I/F to permit the serial communication with the first device upon receipt of a reset signal input from the first device while the operation of the CPU is suspended.

8. The program downloading apparatus according to claim 6,
wherein the second device further has a second serial I/F which communicates with the CPU and transmits a signal indicating the end of execution of a predetermined program and an operation OK/NG signal to the first device, and a second switching unit which switches the second serial I/F to permit the serial communication with the first device upon receipt of a reset signal input from the first device while the operation of the CPU is suspended.

9. The program downloading apparatus according to claim 7,
wherein the second serial I/F is used for the first device to transmit an instruction to the second device to execute a predetermined process.

10. The program downloading apparatus according to claim 8,
wherein the second serial I/F is used for the first device to transmit an instruction to the second device to execute a predetermined process.

11. The program downloading apparatus according to claim 9,
wherein the CPU, the volatile built-in memory, the first switching unit, the first serial I/F, the second serial I/F and the second switching unit are formed on the same semiconductor substrate.

12. The program downloading apparatus according to claim 10,
wherein the CPU, the volatile built-in memory, the first switching unit, the first serial I/F, the second serial I/F and the second switching unit are formed on the same semiconductor substrate.

13. The program downloading apparatus according to claim 1,
wherein the second device is a camera system, the first device is an external device independent of the camera system, and the operating program and the predetermined program constitute a maintenance program of the camera system.

14. The program downloading apparatus according to claim 7,
wherein the second device is a camera system, the first device is an external device independent of the camera system, and the operating program and the predetermined program constitute a maintenance program of the camera system.

15. The program downloading apparatus according to claim 2,
wherein the first device is a master unit of the camera system, the second device is a slave unit of the camera system, the operating program constitutes a main program including a control program and an image processing program of the camera system, and the predetermined program is the image processing program of the camera system.

16. The program downloading apparatus according to claim 8,
wherein the first device is a master unit of the camera system, the second device is a slave unit of the camera system, the operating program constitutes a main program including a control program and an image processing program of the camera system, and the predetermined program is the image processing program of the camera system.

17. The program downloading apparatus according to claim 13,
wherein the external device further has an announcing unit which receives a signal indicating the end of execution of the maintenance program and a signal indicating the operation OK/NG from the camera system and announces the state of the signals.

18. The program downloading apparatus according to claim 14,
wherein the external device further has an announcing unit which receives a signal indicating the end of execution of the maintenance program and a signal indicating the operation OK/NG from the camera system and announces the state of the signals.

19. The program downloading apparatus according to claim 15,
wherein the master unit further has an announcing unit which receives a signal indicating the end of execution of the image processing program and a signal indicating the operation OK/NG from the slave unit and announces the state of the signals.

20. The program downloading apparatus according to claim 16,
wherein the master unit further has an announcing unit which receives a signal indicating the end of execution of the image processing program and a signal indicating the operation OK/NG from the slave unit and announces the state of the signals.

21. The program downloading apparatus according to claim 13,
wherein the second device further has an announcing unit which announces the information on the end of execution of the maintenance program and the operation OK/NG.

22. The program downloading apparatus according to claim 14,
wherein the second device further has an announcing unit which announces the information on the end of execution of the maintenance program and the operation OK/NG.

23. The program downloading apparatus according to claim 15,
wherein the slave unit further has an announcing unit which announces the information on the end of execution of the image processing program and the operation OK/NG.

24. The program downloading apparatus according to claim 16,
wherein the slave unit further has an announcing unit which announces the information on the end of execution of the image processing program and the operation OK/NG.

25. A program downloading method for a system comprising a first device having a flash memory for storing an operating program, and a second device including a CPU, a volatile built-in memory, a nonvolatile external memory for storing a control program of the CPU, and a first switching unit which switches a memory with an address accessed at the time of canceling the reset state, between the nonvolatile external memory and the volatile built-in memory by a switching signal from the first device, wherein the second device uses a predetermined program corresponding to a part or the whole of the operating program downloaded from the first device, the method comprising the steps of:
suspending the operation of the CPU by a suspension signal from the first device;
transmitting a predetermined program to the volatile built-in memory from the first device and storing the predetermined program in the volatile built-in memory while the operation of the CPU is suspended;
canceling the suspension of operation of the CPU by transmitting a suspension cancel signal upon completion of the transmission of the program;
switching a memory with an address accessed by the CPU in response to a switching signal from the first device, from the nonvolatile external memory to the volatile built-in memory; and
executing the predetermined program stored in the volatile built-in memory by a reset signal from the first device.

26. A program downloading method for a camera system comprising a first device including at least a CPU, a flash memory for storing an operating program of the CPU and a serial I/F, and a second device including a CPU, a volatile built-in memory, a nonvolatile external memory for storing the operation program of the CPU and a first switching unit which switches a memory with an address accessed at the time of canceling the reset state, between the nonvolatile external memory and the volatile built-in memory by a switching signal from the first device, the second device using a predetermined program corresponding to a part or the whole of the operating program downloaded from the first device through the serial I/F, the method comprising the steps of:
suspending the operation of the CPU by a suspension signal from the first device;
transmitting a predetermined program to the volatile built-in memory from the first device and storing the predetermined program in the volatile built-in memory while the operation of the CPU is suspended;
canceling the suspension of operation of the CPU by transmitting a suspension cancel signal upon completion of the transmission of the program:
switching a memory with an address accessed by the CPU, from the nonvolatile external memory to the volatile built-in memory in response to a switching signal; and
executing the predetermined program stored in the volatile built-in memory by a reset cancel signal from the first device.

27. A camera system comprising a first device having a flash memory for storing an operating program and a second device using a predetermined program corresponding to a part or the whole of the operating program downloaded from the first device,
wherein the second device comprises a CPU, a volatile built-in memory, a nonvolatile external memory for storing a control program of the CPU, and a first switching unit which switches a memory with an address accessed by the CPU at the time of canceling the reset state, between the nonvolatile external memory and the volatile built-in memory by a switching signal from the first device;
wherein the first device comprises a suspension instruction unit which transmits a suspension signal and suspends the operation of the CPU, a transfer storage unit which transmits the predetermined program to the volatile built-in memory and stores the predetermined program in the voltage built-in memory during the suspension of operation of the CPU, a suspension cancel unit which transmits a suspension cancel signal and cancels the suspension of operation of the CPU upon completion of the transmission of the program, a switching instruction unit which transmits the switching signal to switch a memory with an address accessed by the CPU at the time of cancellation of the reset state, from the nonvolatile external memory to the volatile built-in memory, and an execution instruction unit which transmits a CPU reset state cancel signal and executes the predetermined program stored in the volatile built-in memory.

28. A camera system comprising a first device having at least a CPU, a flash memory for storing an operating program of the CPU and a serial IF, and a second device using a predetermined program corresponding to a part or the whole of the operating program downloaded from the first device through the serial I/F,
wherein the second device comprises a CPU, a volatile built-in memory, a nonvolatile external memory for storing the operating program of the CPU, and a first switching unit which switches a memory with an address accessed by the CPU at the time of canceling the reset state, between the nonvolatile external memory and the volatile built-in memory by a switching signal from the first device;
wherein the first device comprises a suspension instruction unit which transmits a suspension signal and suspends the operation of the CPU, a transfer storage unit which transmits the predetermined program to the volatile built-in memory and stores the predetermined program in the voltage built-in memory while the CPU operation is suspended, a suspension cancel unit which transmits a suspension cancel signal and cancels the suspension of operation of the CPU upon completion of the transmission of the program, a switch instruction unit which transmits the switching signal giving an instruction to switch a memory with an address accessed by the CPU at the time of cancellation of the reset state, from the nonvolatile external memory to the volatile built-in memory, and an execution instruction unit which transmits a CPU reset state cancellation signal and executes the predetermined program stored in the volatile built-in memory.
